(19) United States
(12) Patent Application Publication
(10) Pub. No.: US 2023/0370682 A1
(43) Pub. Date: Nov. 16, 2023

(54) TECHNIQUES FOR ELISION OF REDUNDANT TRANSITION CONTENT AMONG TRACKS IN MEDIA DISTRIBUTION

(71) Applicant: Apple Inc., Cupertino, CA (US)

(72) Inventor: John K. Calhoun, Santa Rosa, CA (US)

(21) Appl. No.: 18/315,174

(22) Filed: May 10, 2023

Related U.S. Application Data
(60) Provisional application No. 63/341,240, filed on May 12, 2022.

(51) Int. Cl. H04N 21/472; G06V 10/74

(52) U.S. Cl. CPC H04N 21/47217; G06V 10/761

(57) ABSTRACT

Media playback techniques are disclosed in which, based on an order of playback among a pair of media elements, a determination is made whether content at an end of a first media element to be played and content at a beginning of a second media element to be played matches each other. When a match is determined, content of the first and second media elements are played in the playback order in a manner that elides one instance of the matching content from the first media element and the second media element. When no match occurs content of the first and second media elements are played in the playback order in a manner in their entirety. These techniques allow content transitions between tracks to be stored in two tracks for download and playback when the tracks are played singly but to play only a single instance of the content transitions when the tracks are played in sequence.

### BACKGROUND

The present disclosure relates to media streaming and to techniques for managing decode and rendering of media content in which certain content elements are contained redundantly in media data.

Modern streaming applications often employ compression algorithms to transmit reduced-bandwidth representations of media from source devices to sink devices. Although operation of compression algorithms may be tailored to the types of content they represent, in general, they exploit content redundancies to generate coded data that consumes less bandwidth in communication networks than the source data.

### BRIEF DESCRIPTION OF THE DRAWINGS

FIG. 1 illustrates a media delivery system according to an aspect of the present disclosure.

FIG. 2 illustrates exemplary coding and partitioning of a work according to an aspect of the present disclosure.

FIG. 3 illustrates a method according to an aspect of the present disclosure.

FIG. 4 illustrates application of the method of FIG. 3 to exemplary tracks in different playback scenarios.

FIG. 5 illustrates exemplary coding and partitioning of a work according to another aspect of the present disclosure.

FIG. 6 represents a data structure of a work according to an aspect of the present disclosure.

FIG. 7 is a block diagram of a sink device according to an aspect of the present disclosure.

### DETAILED DESCRIPTION

Many compression algorithms make “stateful” coding decisions based not only upon redundancies in content but also based upon earlier coding decisions made when processing earlier-presented source data. As a consequence of employing a stateful encoder, a decoder either cannot begin decoding at an arbitrarily-selected element of a coded data stream or it cannot to do without degradation of perceived quality in the resulting presentation. Instead, the decoder must develop a counterpart decoding state, which may involve decoding earlier elements of the coded data stream that sets context for decoding the desired element.

A source content item (called a “work,” for convenience) may contain a variety of subordinate content items within it. Many audio albums, for example, include separately identifiable songs. Many audio/visual works, such as movies and television programming, contain separately identifiable chapters or scenes. It often is convenient to partition works into these subordinate elements (called “tracks,” for convenience) that are separately accessible by sink devices. When processed by a stateful encoder, it may occur that an entire work is coded by the encoder in a first processing operation, then partitioned into tracks by a second processing operation. To avoid artifacts during rendering, it may occur that individual tracks, as stored, contain content that belongs to other tracks. The beginning and ending of track content may be signaled in metadata provided with manifest file(s) for the work and/or the track.

Moreover, artists routinely generate audio/visual works in ways that challenge preconceptions regarding how those works are to be represented in media distribution systems. For example, where many artists will compose songs and videos as discrete elements that have recognizable beginnings and ends, other artists compose works that are not traditionally bounded. They may create tracks whose endings, and the beginnings of a next track that follows, are not discrete. Instead, these transitions may contain content that render demarcations between content indistinct. The creativity of these artists also can challenge traditional representations of their works in media distribution systems.

Aspects of the present disclosure provide techniques for media playback in which, based on an order of playback among a pair of tracks, a determination is made whether content at an end of a first track to be played and content at a beginning of a second track to be played matches each other. When a match is determined, content of the first and second tracks are played in the playback order in a manner that plays only one instance of the matching content from the first track and the second track. When no match occurs, content of the first and second tracks are played according to start times and end times defined for them. These techniques allow content transitions between tracks to be provided redundantly in two tracks for storage and download but to play only a single instance of the content transition when the tracks are played in sequence.

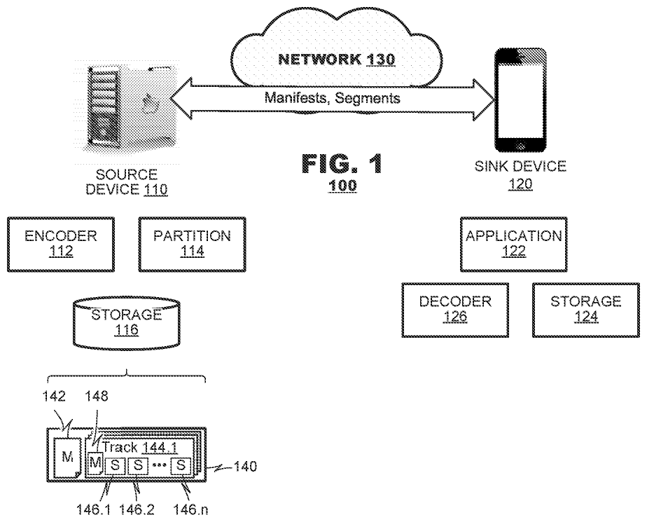

FIG. 1 illustrates a media delivery system 100 according to an aspect of the present disclosure. The system 100 may include a source device 110 and a sink device 120 provided in mutual communication via a communication network 130. The source device 110 may provide media data to the sink device 120 over the communication network 130. The sink device 120 may receive and consume the media data according to a local rendering context. In a simple application, the sink device 120 simply may render requested content via output devices such as a local display and/or speakers (not shown). Alternatively, the sink device 120 may integrate requested content with other content generated locally by an application 122 executing locally on the sink device 120. Further, in some applications, the requested content may be placed in local storage 124 on the sink device 120 for later processing.

As discussed, media data may be exchanged between the source and sink devices 110, 120 in bandwidth-compressed representations. Thus, the source device 110 may process source media by an encoder 112 and a partitioning unit 114. Tracks generated from the encoding and partitioning processes may be stored in local storage 116 for later addressing and retrieval by sink devices 120. Sink devices 120 may have decoders 126 that decode tracks coded by the source device's encoder 112.

At a source device 110, coded data of a work 140 may be stored in a format that is amenable for delivery to sink devices 120. For example, the source device 110 may store data of the work 140 as a manifest file 142 and a plurality of tracks 144.1-144.n (only one track shown in FIG. 1). The manifest file 142 may store metadata that describes content of the work 140 including, for example, data identifying the tracks 144.1-144.n that are part of the work 140, their durations, the sequence of the 144.1-144.n tracks within the work 140, and network location(s) from which the tracks 144.1-144.n may be retrieved. In one aspect, only one manifest file 142 may be provided per work 140, but, in others, manifest files may be defined as hierarchical and separately accessible data structure with a root manifest file 142 and other manifest files 148 provided per track. The tracks may be organized further into segments 146.1-146.n, representing units of data for retrieval by the sink device 120.

The representation of the work 140 among manifest file(s), tracks, and segments provides efficiencies in streaming applications. A sink device 120 may access information about the work 140 by downloading the manifest file(s) 142, 148. The sink device 120 may identify from the manifest file(s) 142, 148 information about the track(s) that it is to download and render, then issue requests for the identified track(s). Identification of the tracks may be performed with reference to a playback context that is defined for the sink device 120. For example, if the sink device 120 has been commanded (by a user (not shown)) to play the work 140 in its entirety, the sink device 120 may retrieve the tracks (and segments therefor) in an order determined by an author of the work 140 as represented in the manifest file. Alternatively, the sink device 120 may have been commanded to play a single track from the work, to play tracks of the work 140 in a random order (shuffle play), or to play track(s) of the work 140 with tracks from other works (not shown) according to a playlist. The sink device 120, therefore, may issue requests for tracks according to the playback context that is defined for it.

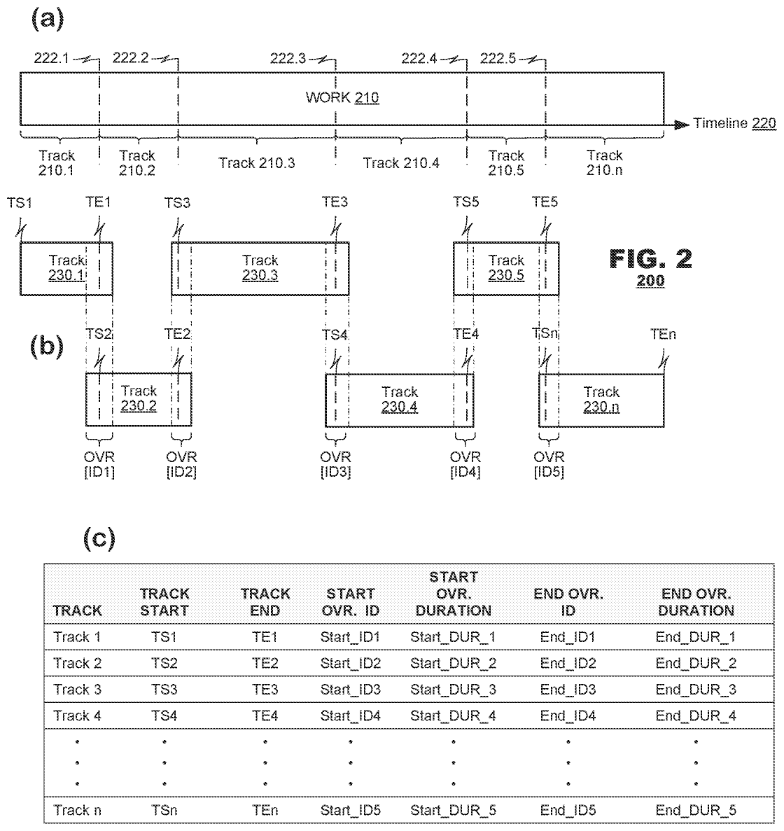

FIG. 2 illustrates exemplary coding and partitioning of a work according to an aspect of the present disclosure. FIG. 2(a) illustrates a single work 210 containing a plurality of tracks 210.1-210.n as they may be perceived by an audience. Partitions 222.1-222.5 between the tracks 210.1-210.n may occur at respective locations along a work timeline 220. As discussed, an encoder 112 (FIG. 1) may code the work 210 as a unitary element, and a partitioning unit 114 may partition the coded work according to the track partitions 222.1-222.n−1, generating a plurality of tracks 230.1-230.n as shown in FIG. 2(b). The tracks 230.1-230.n may be stored 116 (FIG. 1) for access and retrieval by sink devices 120.

It often may occur that, owing to the coding and partitioning processes, that stored tracks 230.1-230.2 will not start and end precisely at the partitions 221.1-222.5 that would be perceived by an audience. Coding often generates dependencies among coded content that make it necessary for a sink device to have access to coding data corresponding to content at a time earlier than a track's start. Thus, the partitioning process may generate stored tracks 230.1-230.n that contain content that overlaps each other, represented by OVR in FIG. 2. For example, a stored track (say track 230.2) may have content that overlaps content of a preceding track 230.1 and/or content that overlaps content of a succeeding track 230.3. Manifest file(s) 142, 148 may store indicators TS1, TE1, TS2, TE2, . . . , TSn, TEn that identify the beginnings and ends of content for the respective tracks 230.1-230.n that should be played. The manifest file(s) 142, 148 also may store identifiers ID1, ID2, . . . , ID5 of overlaps as they occur in the respective tracks 230.1-230.n.

FIG. 2(c) illustrates exemplary metadata 240 that may be stored for the tracks 230.1-230.n of FIG. 2(b). The metadata includes, for each track, fields identifying a timestamp of the track's start for rendering purposes (e.g., TS1), the track's end for rendering purposes (TE1), an overlap identifier (Start_ID1) identifying presence of content overlap at the beginning of the track, data representing a duration of the overlap (Start_DUR_1), an overlap identifier (End_ID1) identifying presence of content overlap at the end of the track, and data representing a duration of the overlap (End_DUR_1). Overlap identifiers and their respective durations may contain null data when there is no overlap between stored tracks. For example, the very first track 230.1 will have no overlap identifier provided for the start of that track; by definition, there is no track that precedes the first track 230.1 to provide an overlap at the track's start.

In an aspect, overlap identifiers may be identified by a sample group type in a manner described in the Base Media File Format of ISO/IEC 14496-12:2020 § 8.9; an appropriate sample group type identifier may be defined for this purpose, such as a group description called “seam.”

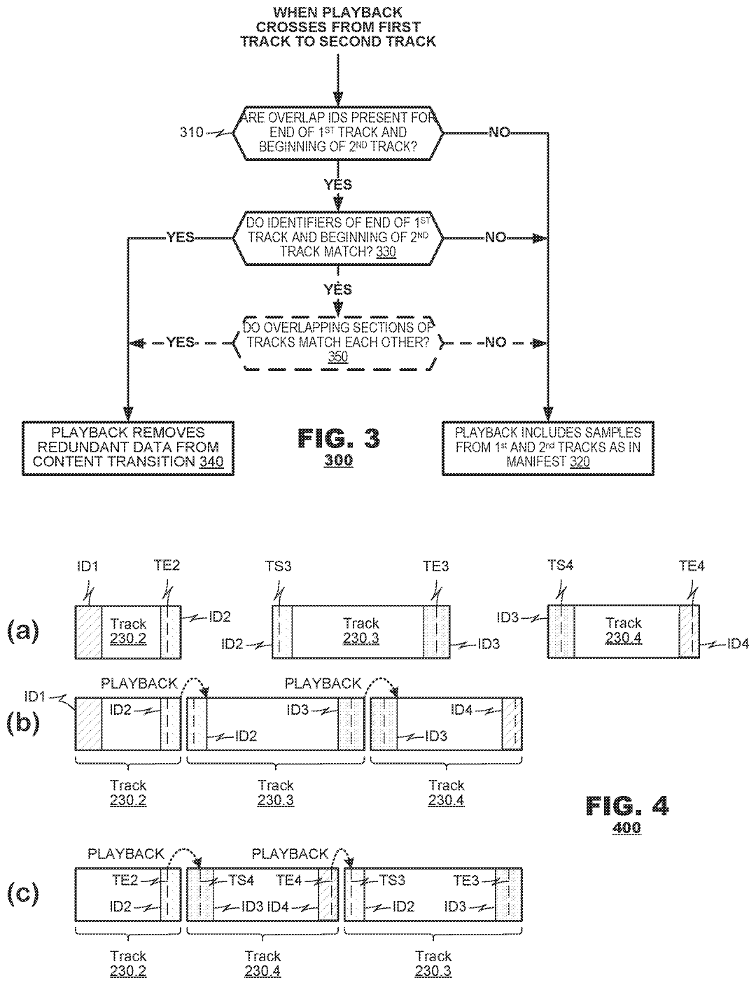

FIG. 3 illustrates a method 300 according to an aspect of the present disclosure. The method 300 may govern playback operations for tracks in which content transitions may be present. The method 300 may be invoked when a sink device (FIG. 1) determines that playback will cross from a first track to a second track. In this case, the method 300 may determine whether overlap identifiers are present for the end of the first track and the beginning of the second track (box 310). If overlap identifiers are not present for both tracks, then the method 300 may cause the first and second tracks to be played according to the end and start times as represented in the manifest file (box 320). If overlap identifiers are present for both tracks, the method 300 may determine if the overlap identifiers from the end of the first track and from the beginning of the second track match each other (box 330). If not, then the method 300 may advance to box 320 and play the tracks according to the end and start times represented in the manifest file. If the content identifiers from the end of the first track and the beginning of the second track match each other, then the method 300 may cause redundant data from one of the content transitions to be removed from playback (box 340).

FIG. 4 illustrates application of the method 300 (FIG. 3) to exemplary tracks 230.3-230.4 from FIG. 2 in different playback scenarios. In this example, as shown in FIG. 4(a), the tracks each contain overlap transitions. A first overlap transition extends between tracks 230.2 and 230.3 and has a first identifier ID2 defined for it. A second overlap transition extends between tracks 230.3 and 230.4 and has a second identifier ID3 defined for it.

In the playback example of FIG. 4(b), track 230.2 is to be played first, followed by track 230.3 second, and track 230.4 third. When the method 300 is applied to tracks 230.2 and 230.3, the method 300 would determine from a matching overlap identifier ID2 that an overlap transition exists between tracks 230.2 and 230.3 and would schedule playback so that a redundant instance of content at the overlap transition ID2 is omitted from playback. In this instance, playback would extend from track 230.2 to 230.3 with only a single instance of content in the overlap transition identified by ID2 being played.

So, too, with the overlap transition that extends between tracks 230.3 and 230.4. The method 300 would determine from another matching overlap identifier ID3 that an overlap transition exists between tracks 230.3 and 230.4 and would schedule playback so that a redundant instance of content at the overlap transition is omitted from playback. In this instance, playback would extend from track 230.3 to 230.4 with only a single instance of content in the overlap transition identified by ID3 being played.

In an aspect, when matching identifiers exist between consecutively-played tracks that are generated from a unitary encoding (e.g., ID2 for tracks 230.2 and 230.3), one instance of redundant content can be elided from the tracks 230.2, 230.3 before they are processed by a decoder 126 (FIG. 1). In such an application, sink device processing resources that otherwise would be consumed by decoding the second track 230.3 in full can be avoided. Such processing resources often involve developing a coding state of the decoder 126 for track 230.3 without regard to coding state that would have been developed from track 230.2. Application of the method 300, however, effectively aggregates the two tracks 230.2, 230.3 into a larger “track” wherein the coding state for the content of track 230.3 that follows the overlap transition ID2 is developed from decoding of track 230.2 rather being reset by decoding the content of the overlap transition ID2 in track 230.3. In this manner, the method 300 further conserves resources in a sink device 120 (FIG. 1).

In the playback example of FIG. 4(c), track 230.2 is to be played first, followed by track 230.4 second, and track 230.4 third. When the method 300 is applied to tracks 230.2 and 230.4, the method 300 would determine from ID1 and ID2 that a mutual overlap transition does not exist between tracks 230.2 and 230.4. Accordingly, the method 300 would schedule playback so that content of track 230.2 is decoded and played through to its end point TE2. The method 300 further would schedule playback of track 230.4 so that it commences at its start point TS4. Track 230.4, however, would be decoded from the onset of the track 230.4 (e.g., the beginning of the span identified by ID3), which may set the state of the decoder 126 (FIG. 1).

A similar result may be achieved when the method 300 evaluates the transition from track 230.4 to track 230.3. In this example, no overlap transition is identified at the end of track 230.4 due to overlap transition mismatches. In this circumstance, because there is no overlap transition identified for the end of the track, the method 300 would schedule playback so that content of track 230.4 is played through to its end TE4 and playback of track 230.3 commences at its start TS3. Again, decoding of track 230.3 may commence at the beginning of the track 230.3 as may be required to set state of decoder 126 (FIG. 1).

Overlap identifiers may be employed to enhance streaming functionality in other ways. For example, it often occurs that content providers edit tracks after they are first published for consumption. In such an application, one track (say track 230.3 in FIG. 2) may be revised after first publication and other tracks 230.1-230.2, 230.4-230.n may be left unchanged. When a track 230.3 is changed in a way that makes it inappropriate for the method 300 (FIG. 3) to alter playback as represented by box 340, overlap identifiers may be altered to prevent the method 300 from creating a match between consecutive tracks. In the example where track 230.3 is altered, an overlap identifier at the end of track 230.3 may be revised to a value that differs from the overlap identifier provided at the beginning of track 230.4 which forces the method 300 to reject the overlap identifiers as a match. In such an instance, the method 300 would apply processing as in box 320.

In another aspect, detection of modified tracks also may be performed by the method 300 as represented in box 350. There, even when overlap identifiers from adjacent tracks are identified as a match, the method 300 may compare track content in the spans identified by the matching overlap identifiers and determine whether they match each other. If the overlapping sections of the tracks do not match each other, then the method 300, may play content of the tracks as represented by the track's respective endings and starts. If a match is determined, the method may process the tracks as represented in box 340.

Content matches may be determined in a variety of ways. In one aspect, a match may be determined if the temporal durations of the tracks, as identified by their respective overlap identifiers or accompanying information, match each other. In another aspect, a match may be determined if the content of the tracks prior to decode as identified by their respective overlap identifiers, match each other. In a further aspect, a match may be determined if the content of the tracks after decode as identified by their respective overlap identifiers, match each other. Performing content matches as represented in box 350 may detect instances where track content has been altered, for example, after track(s) have been released for streaming.

In one aspect, a match may require not only identical identifiers of overlapping samples but also that the temporal durations of the tracks, as identified by their respective overlap identifiers or by accompanying information, indicate that all of the output from overlapping samples is required for the presentation of the full duration of either one track or the other but that no portion of the output is required for both.

In an aspect, content matches may be determined from a sliding window comparison of track content. When comparing tracks generated from like-kind coding techniques, sample comparisons may be made on a pre-decoded representations of track content and the sliding window comparison may be performed prior to decoding by a sink device 210. In other circumstances, for example, where different types of predictive coding are applied in the different tracks, the sliding window comparison may be performed on post-decoded representations of track content.

In another aspect, overlap identifiers may include or be accompanied by information identifying the temporal durations and/or counts of samples within the overlap region of a track. In such cases, content matches may be performed on the portions of possibly overlapping content so identified.

Identification of temporal durations may employ different syntax elements in different communication protocols. For example, temporal durations may be identified via edit boxes as described in ISO/IEC 14496-12:2020 § 8.6.5. Alternatively, temporal be identified via use of separate entities in a TimeToSampleBox (“stts”) as described in ISO/IEC 23008-3:2015/Amd.2:2016 § 22 for MPEG-H audio. Other protocols may identify these temporal durations in different ways.

Application of the different aspects of the method 300 may have different consequences for operation of sink devices 120 (FIG. 1). In one aspect, where the decision to apply processing of box 340 is made solely from evaluation of a work's manifest file, the method 300 may be applied on a forward-looking basis before content of the tracks have been retrieved from a source device 110.

In another aspect, where the decision to apply processing of box 340 is made based on a comparison of track content (box 350), the method 300 may be resolved after relevant content of the tracks have been downloaded. In such applications, a sink device 120 (FIG. 1) may not always have content of a second track to be played at the time a first track is being decoded and/or rendered. In an aspect, a sink device 120 may prospectively include track content that corresponds to an overlap transition from a first track (e.g., ID2 of track 230.2 in FIG. 4) for decoding in the absence of track content for the second track 230.3. The method 300 may resolve itself after content of the next track, whether track 230.3 in the example of FIG. 4(b) or track 230.4 in the example of FIG. 4(c), when it becomes available. If a match is determined as in the FIG. 2(b) use case, the second instance of overlapping content from track 230.3 may be elided from decoding and/or playback.

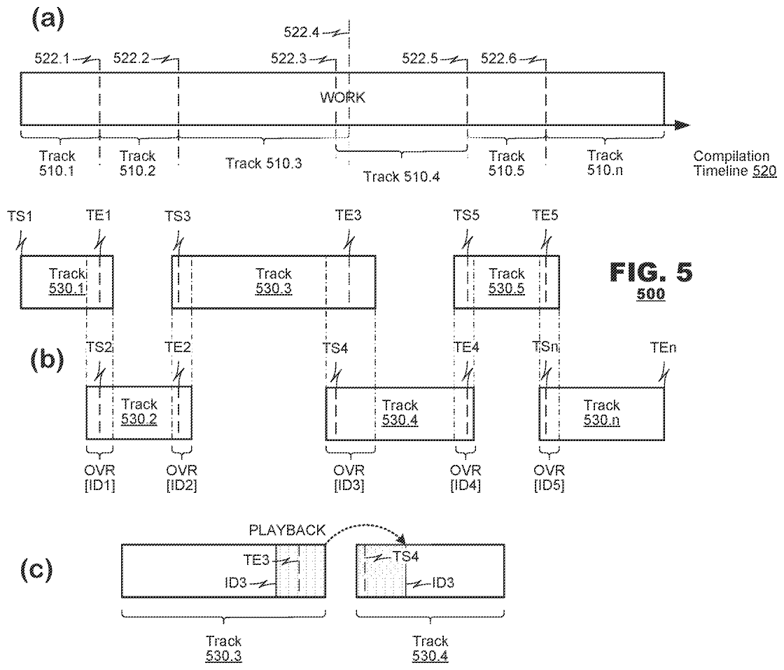

The principles of the present disclosure also find application in circumstances where works, as authored, provide overlapping transitions among track content. It may occur that authors of a work 510 define tracks 510.1-510.n in a way that provides continuity in content (called a “content transition” for convenience) as one track begins and a following track begins. FIG. 5 illustrates application of a coding and partitioning system to an exemplary work 500 in which a content transition occurs between tracks 510.3 and 510.4. In this example, an audience may perceive track 510.3, if it were played in isolation without track 510.4, as extending through position 522.4 on the work's timeline 520. Similarly an audience may perceive track 510.4 as beginning at position 522.3 on the timeline 520 if it were played in isolation without track 510.3. An audience, however, would perceive a playback error to have occurred if the content between positions 522.3 and 522.4 were played twice when tracks 510.3 and 510.4 are played in order.

In this circumstance, stored tracks 530.1-530.n may be created by the coding and partitioning processes described above. Overlap identifiers ID1-ID5 also may be applied. When tracks 530.3 and 530.4 are to be played in succession, application of the method 300 (FIG. 3) may identify a match of overlap identifiers ID3 and determine to elide one instance of overlapping content from playback. Thus, only a single instance of the content transition that occurs between positions 522.3 and 522.4 on the content timeline 520 would be rendered. The perceived playback error that would arise if the content transition were rendered twice can be avoided. In other playback scenarios, where track 530.3 or track 530.4 are to be rendered in isolation, the method 300 will render the tracks according to the end TE3 or start TE4 times identified for the respective track.

In the example of FIG. 5, the partitions 522.1-522.2 and 522.5-522.6 are shown as having discrete boundaries between their respective tracks for ease of discussion. The principles of the present discussion extend, of course, to works having more than one content transition between tracks.

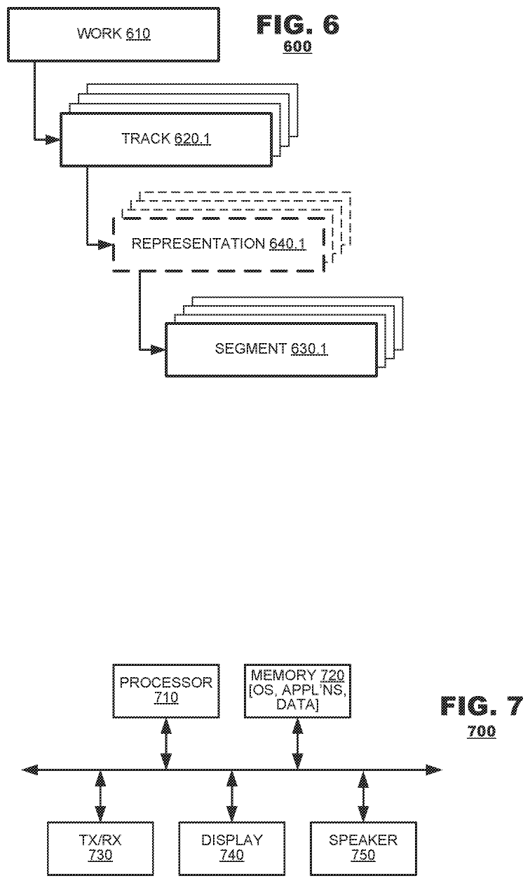

FIG. 6 represents a data structure 600 of a work according to an aspect of the present disclosure. As illustrated the data structure 600 may include a hierarchy of data elements that organize content of the work 600 according to its constituent elements. The data structure 600 may possess a root node 610 representing the work, nodes 620.1-620.m representing tracks contained within the work, and nodes 630.1-630.k representing segments contained within each of the tracks. Metadata may be provided at each node providing data relating to the respective node and identifying sub-nodes that are linked to it. The metadata may be provided in a single metadata element 142 (FIG. 1) for the entire work or, as convenient, may be distributed among a hierarchy of metadata elements 142, 148 (FIG. 1).

The data structure 600 may accommodate other data elements to fit other needs. For example, it may be convenient to provide data structures for different representations of tracks. In many coding applications, it may be convenient to provide multiple representations of a single track to fit other coding environments. In video streaming applications, content representations may vary based on the size of video contained in the different representations (for example, 720p, 1080p, 4K, etc.). In audio streaming applications, content representations may vary based on the number of channels provided for audio rendering, for languages, and the like. Thus, the different representations may represent the same authored content but may vary based on the coded representation of that content. In a streaming application, the representations may differ from each other in terms of the coding algorithms applied or the data bitrates that are required to represent content in the respective representation. In such applications, where a coding state developed from decode of a track in one representation would not apply to a track from another representation, overlap identifiers may be defined to force detection of a mismatch and processing as in block 320 (FIG. 3).

The techniques described herein have been disclosed in the context of sink and source devices 110, 120 (FIG. 1) that are provided in mutual communication. Although the sink device 120 is shown as a smartphone, the principles of the present disclosure apply to a wide variety of devices that receive and render media content, including, for example, smart-speaker systems, gaming systems, tablet computers, laptop and notebook computers, personal computers, television systems, head-mounted display systems, and the like. The sink device 120 may execute programs that are stored in memory of those devices and be executed by processors within them. Alternatively, they can be embodied in dedicated hardware components such as application specific integrated circuits, field programmable gate arrays and/or digital signal processors. And, of course, these components may be provided as hybrid systems that distribute functionality across dedicated hardware components and programmed general purpose processors, as desired.

FIG. 7 is a block diagram of a sink device 700 according to an aspect of the present disclosure. The sink device 700 may include a processor 710 and a memory 720. The memory 720 may store program instructions that define an operating system and various applications that are executed by the processor 710, including, for example, a media streaming application. The memory 720 also may store application data for each of the applications. The memory 720 may include a computer-readable storage media such as electrical, magnetic, or optical storage devices.

The sink device 700 may possess a transceiver system 730 to communicate with other system components, for example, source device(s) via a communication channel. The transceiver system 730 may communicate with a wide variety of wired or wireless electronic communications networks.

The sink device also may include display(s) and/or speaker(s) 740, 750 to render media during playback.

Several embodiments of the disclosure are specifically illustrated and/or described herein. However, it will be appreciated that modifications and variations of the disclosure are covered by the above teachings and within the purview of the appended claims without departing from the spirit and intended scope of the disclosure. The present specification describes components and functions that may be implemented in particular embodiments, which may operate in accordance with one or more particular standards and protocols. However, the disclosure is not limited to such standards and protocols. Such standards periodically may be superseded by faster or more efficient equivalents having essentially the same functions. Accordingly, replacement standards and protocols having the same or similar functions are considered equivalents thereof.

We claim:

1. A media playback method, comprising:
determining an order of playback among a pair of tracks,
determining whether content at an end of a first track to be played and content at a beginning of a second track to be played matches each other;
when a match is determined, playing content of the first and second tracks in the playback order in a manner that plays only one instance of the matching content from the first track and the second track.

2. The method of claim 1, further comprising, when no match is determined, playing content of the first and second tracks in the playback order in a manner that includes playing the content at the end of the first track and playing the content at the beginning of the second track.

3. The method of claim 1, further comprising, when the match is determined, decoding content of the first and second tracks in a manner that decodes only one instance of the matching content from the first track and the second track.

4. The method of claim 1, wherein a match is determined from a comparison of identifiers indicating respective overlap transitions at the end of the first track and at the beginning of the second track.

5. The method of claim 4, wherein the identifiers include a sample group type provided in an ISO/IEC 14496-12 format.

6. The method of claim 4, wherein a match is determined from a comparison of a number of samples indicated in the respective identifiers.

7. The method of claim 4, wherein the identifiers are stored in manifest file(s) that identify network locations from which the first and second tracks are to be retrieved.

8. The method of claim 1, wherein a match is determined from a comparison of samples contained at the end of the first track to samples contained at the beginning of the second track.

9. The method of claim 8, wherein the samples to be compared are identified by temporal duration identifiers provided in a manifest file relating to the tracks.

10. The method of claim 9, wherein a temporal duration identifier is identified in an edit box conforming to ISO/IEC 14496.

11. The method of claim 9, wherein a temporal duration identifier is identified in a TimeToSampleBox conforming to ISO/IEC 23008.

12. The method of claim 1, wherein the first and second tracks contain audio content.

13. The method of claim 1, wherein the first and second tracks contain video content.

14. A media decoding method, comprising:
determining an order of playback among a pair of tracks,
determining whether content at an end of a first track to be played and content at a beginning of a second track to be played matches each other;
when a match is determined, scheduling decoding of the first and second tracks in the playback order in a manner that includes only one instance of the matching content from the first track and the second track; and
decoding content of the first and second tracks according to the scheduling.

15. The method of claim 14, further comprising playing the decoded content.

16. The method of claim 14, wherein the identifiers include a sample group type provided in an ISO/IEC 14496-12 format.

17. The method of claim 14, wherein a match is determined from a comparison of a number of samples indicated in the respective identifiers.

18. The method of claim 14, wherein the first and second tracks contain audio content.

19. The method of claim 14, wherein the first and second tracks contain video content.

20. A media playback method, comprising:
determining an order of playback among a pair of tracks,
comparing a pair of identifiers, a first identifier representing content at an end of a first track to be played and a second identifier representing content at a beginning of a second track to be played;
when the identifiers do not indicate a match, playing content of the first and second tracks in the playback order, including playing the content identified by the identifiers; and
when the identifiers indicate a match, playing content of the first and second tracks in the playback order in a manner that omits one instance of content identified by the identifiers.

21. The method of claim 20, wherein the identifiers include a sample group type provided in an ISO/IEC 14496-12 format.

22. The method of claim 20, wherein a match is determined from a comparison of a number of samples indicated in the respective identifiers.

23. The method of claim 20, wherein the identifiers are provided a manifest file of the media item, the manifest file identifying network locations from which the tracks are downloadable.

24. The method of claim 20, wherein the identifiers include respective ID values.

25. The method of claim 24, wherein the identifiers also include values identifying a number of samples in the respective elements.

26. The method of claim 20, wherein the tracks represent respective elements of an audio work.

27. The method of claim 20, wherein the tracks represent respective scenes of a video work.

28. A computer readable medium having program instructions stored thereon that, when executed by the processor, cause the processor to:
determine an order of playback among a pair of tracks,
determine whether content at an end of a first track to be played and content at a beginning of a second track to be played matches each other;
when a match is determined, play content of the first and second tracks in the playback order in a manner that elides one instance of the matching content from the first track and the second track.

29. The medium of claim 28, wherein, when no match is determined, the instructions cause the processor to play content of the first and second tracks in the playback order in a manner that includes playing the content at the end of the first track and playing the content at the beginning of the second track.

30. The medium of claim 28, wherein the instructions cause the processor to determine a match from a comparison of identifiers indicating respective overlap transitions at the end of the first track and at the beginning of the second track.

31. The medium of claim 30, wherein the identifiers include a sample group type identifier provided in an ISO/IEC 14496-12 format.

32. The medium of claim 28, wherein the instructions cause the processor to determine a match from a comparison of a number of samples indicated in the respective identifiers.

33. The medium of claim 28, wherein the instructions cause the processor to determine a match from a comparison of samples contained at the end of the first track to samples contained at the beginning of the second track.

34. The medium of claim 28, wherein the first and second tracks contain audio content.

35. The medium of claim 28, wherein the first and second tracks contain video content.

36. A processing device, comprising:
a processor, and
a memory storing program instructions that, when executed by the processor, cause the processor to:
determine an order of playback among a pair of tracks,
determine whether content at an end of a first track to be played and content at a beginning of a second track to be played matches each other;
when a match is determined, play content of the first and second tracks in the playback order in a manner that elides one instance of the matching content from the first track and the second track,
at least one media rendering device to play the content of the first and second tracks.
